(19) United States
(12) Patent Application Publication
(10) Pub. No.: US 2025/0383878 A1
(43) Pub. Date: Dec. 18, 2025

(54) MEMORY DEPENDENCE PREDICTION IN A PARALLEL ARCHITECTURE WITH COMPUTE SLICES

(71) Applicant: Ascenium, Inc., Mountain View, CA (US)

(72) Inventor: Hans Olle Viktor Fredriksson, 0187 Oslo (NO)

(73) Assignee: Ascenium, Inc., Mountain View, CA (US)

(21) Appl. No.: 19/235,822

(22) Filed: Jun. 12, 2025

Related U.S. Application Data
(60) Provisional application No. 63/659,401, filed on Jun. 13, 2024.
(60) Provisional application No. 63/744,394, filed on Jan. 13, 2025.

(51) Int. Cl. G06F 9/38; G06F 9/30; G06F 9/355

(52) U.S. Cl. CPC G06F 9/3838; G06F 9/30043; G06F 9/355

(57) ABSTRACT

A processing unit is accessed that includes a plurality of compute slices, a control unit, and a global aliasing table (GAT). Each compute slice within the plurality of compute slices includes at least one execution unit, is known to a compiler, and is coupled to a successor compute slice and a predecessor compute slice. A first compute slice executes a load instruction. The load instruction is associated with a target address. The load instruction is predicted that it will alias with a previous store instruction. The previous store instruction executes on a previous compute slice among the plurality of compute slices. The predicting is based on the GAT. The load instruction is stalled until the previous store instruction completes execution on the previous compute slice. The load instruction is allowed to execute. The predicting includes searching, in the GAT, for an entry which includes the load instruction.

### RELATED APPLICATIONS

This application claims the benefit of U.S. provisional patent applications “Memory Dependence Prediction In A Parallel Architecture With Compute Slices” Ser. No. 63/659,401, filed Jun. 13, 2024, and “Code Translation And Forwarding With Compute Slices” Ser. No. 63/744,394, filed Jan. 13, 2025.

Each of the foregoing applications is hereby incorporated by reference in its entirety.

### FIELD OF ART

This application relates generally to checking memory operations and more particularly to memory dependence prediction in a parallel architecture with compute slices.

### BACKGROUND

Computing technology has significantly improved data processing by corporations, hospitals, researchers, and schools, among many others. Continued advancements in each of these areas propel development of new theories, models, and applications. These computation successes drive increased demand for further advancements in computing technologies. Thus, demand drives improvements in computing, and improvements in computing achieve greater processing objectives. The computing technologies that are brought to bear on processing can be large and complex. Modern technologies, based on logic gates, are vastly different from the very earliest electronic computers. Conceptually, the idea of using vacuum tubes as logic gates was established prior to 1920. However, the first vacuum tube computer was not developed until the late 1930s. The ENIAC computer soon followed with its thousands of vacuum tubes that required copious amounts of electricity while only providing a then heady 450 floating point operations per second (FLOPS).

The processing power of vacuum tube-based computers evolved over the next few decades. The invention of the transistor in 1947 enabled a new generation of computers that supported execution of applications that could not previously be processed with vacuum-tube technology. Further, new programming techniques were developed as processing power increased. Programming languages such as COBOL and FORTRAN were created to replace obsolete punch cards. These programming languages significantly improved processing techniques by making compute resources more accessible to engineers solving ever more complex problems. In the late 1950s, the first integrated circuit (IC) was created, and with it, a new era in computer technology. ICs accelerated the rate of technological change, enabling the development of the first general purpose microprocessor, the DRAM chip, and the floppy disk drive controller. The first marketable personal computers were based on these remarkable devices.

A dizzying array of electronic devices now includes at least one microelectronic processor. Personal electronic devices, smart homes, vehicles, and more contain processors that make the devices far more useful than previously imagined. Present day smartphones, for example, now possess more than a million times the compute power of the early computers. A standard personal computer today is roughly capable of tens of gigaFLOPs (1 billion floating point operations per second). And, the world's fastest supercomputer today is vastly more powerful than early computers, with more than eight million processor cores, and a total processing power surpassing one exaFLOP (1 quintillion floating point operations per second). Predictably, this exponential increase in compute power has opened a world of new and powerful applications. Augmented reality, genomic sequencing, machine learning, artificial intelligence, cancer treatments, and autonomous vehicles are just a small sample of what has become possible with the power of modern high-performance processors and computer systems. In the future, human ingenuity will surely continue to push the technical boundaries of possibility as more processing power and new applications become available.

### SUMMARY

New computing architectures, circuit families, fabrication techniques, and materials that enable advances in computing have been developed. These developments have been accomplished by electrical and process engineers, material scientists, and others over the previous several decades. These important advances have brought about dramatic improvements in computing, enabling previously unobtainable data processing techniques. Further, these developments have supported more complex simulations and models, and have spawned computational fields such as artificial intelligence and deep learning. The computational requirements of these advanced techniques, models, and fields quickly overwhelmed previous computational capabilities, thereby spurring development of new architectures, circuits, and so on. The “arms race” between computational resource advances and computational requirements continues to this day and is widely predicted to last long into the future. However, providing more capable resources has become exceedingly difficult. Faster clock speeds have been implemented successfully to increase processing capability, but faster speeds make designs more complex. Further, circuit power consumption and heat dissipation have severely limited the extent to which clock speeds can be pushed. As a result, the increase in processor clock rates has been limited because cooling technologies have not been able to keep pace with excessive heat dissipation of modern designs. Code execution parallelism has offered an additional method to increase performance. For example, a microprocessor chip can include any number of smaller processor cores, each able to perform operations in parallel. This approach, while common, has required engineers to devise methods that ensure that each core has access to read from and write to memory. The system must also be prevented from accessing “stale” or invalid data by delivering the most up-to-date data to all processing elements when the data is required. As increased parallelism has been added to microprocessor chips, memory system design has become a significant challenge. Techniques for memory dependence prediction in a parallel architecture with compute slices that address the continued need for increased performance are disclosed.

Techniques for memory dependence prediction in a parallel architecture with compute slices are disclosed. A processing unit is accessed. The processing unit can be based on one or more integrated circuits or chips, application-specific chips, programmable chips, and so on. The processing unit includes various electronic elements that enhance the unit. The electronic elements include a plurality of compute slices, a control unit, and a global aliasing table (GAT). The GAT can be used to store speculative loads that can alias to a store associated with a slice task that is executing non-speculatively. The electronic elements can further include a memory system. Each compute slice is coupled to a successor compute slice and a predecessor compute slice. The coupling of compute slices can be accomplished using barrier registers. A first compute slice among the plurality of compute slices executes a load instruction. The load instruction can be associated with a slice task that is executing speculatively. The load instruction is associated with a target address. The load instruction is predicted to alias with a previous store instruction. The previous store instruction can be associated with the slice task that is executing non-speculatively. The previous store instruction executes on a previous compute slice among the plurality of compute slices. The predicting is based on one or more entries in the GAT. The load instruction is stalled until the previous store instruction completes execution on the previous compute slice. Otherwise, the load instruction would occur “too early,” resulting in a memory access race condition. The load instruction is allowed to execute. With the correct value finally stored, the stalled load instruction can be restarted.

A processor-implemented method for checking memory operations is disclosed comprising: accessing a processing unit comprising a plurality of compute slices, a control unit, and a global aliasing table (GAT), wherein each compute slice within the plurality of compute slices includes at least one execution unit, is known to a compiler, and is coupled to a successor compute slice and a predecessor compute slice; executing, by a first compute slice among the plurality of compute slices, a load instruction, wherein the load instruction is associated with a target address; predicting that the load instruction will alias with a previous store instruction, wherein the previous store instruction executes on a previous compute slice among the plurality of compute slices, and wherein the predicting is based on the GAT; stalling the load instruction until the previous store instruction completes execution on the previous compute slice; and allowing the load instruction to execute. In embodiments, the predicting includes searching, in the GAT, for an entry which includes the load instruction, wherein the entry which includes the load instruction is not found. In embodiments, the load instruction aliased with the previous store instruction. Some embodiments comprise saving, in an entry of the GAT, an instruction address of the load instruction, wherein the instruction address of the load instruction is associated, in the entry of the GAT, with an instruction address of the previous store instruction. In embodiments, the saving includes a saved slice offset, wherein the saved slice offset comprises X+1, wherein X is a number of compute slices between the first compute slice and the previous compute slice. Some embodiments comprise restarting one or more compute slices among the plurality of compute slices, wherein the restarting includes the first compute slice, a tail slice, and every compute slice between the first compute slice and the tail slice.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for memory dependence prediction in a parallel architecture with compute slices.

FIG. 2 is a flow diagram for predicting aliasing.

FIG. 3 is a block diagram for a ring configuration of compute slices.

FIG. 4 is a block diagram for a ring configuration of compute slices and local memory disambiguation units.

FIG. 5 is a diagram of a global aliasing table (GAT).

FIG. 6 is a block diagram for determining slice offset.

FIG. 7 is a block diagram for memory dependence prediction.

FIG. 8 is a system diagram for memory dependence prediction in a parallel architecture with compute slices.

### DETAILED DESCRIPTION

Artificial intelligence, deep learning, and other computationally intensive processing applications are widespread modern computational objectives. Applications such as these and others are continuously propelling the requirement for ever greater compute power. Many computationally intensive techniques are increasingly being applied even to mundane tasks and day-to-day tasks. Organizations with computational requirements ranging from the modest to the complex are faced with a nearly continuous need to upgrade their compute resources in order to remain competitive. Hardware techniques such as designs based on faster processor clock speeds have been successfully applied to increase the processing capabilities of modern compute systems. That said, there are significant performance limitations to merely increasing clock frequencies because of architectural and physical design limitations. Cooling technologies have been woefully inadequate to meet heat dissipation demands of processor technologies based on improved lithography and increased clock frequencies. Instead, other methods of performance improvements, such as computational parallelism, are being actively explored.

Implementing computational parallelism can be accomplished by increasing the number of execution units in a processor, and/or adding multiple processor cores to a given integrated circuit or chip. The parallelism enables threading within the processor. These design options increase overall performance by enabling the system to take advantage of more instruction level parallelism (ILP). However, these approaches introduce significant cost and complexity, in part due to the “too many cooks” problem. For example, instructions and data must be provided and must move efficiently and concurrently in and out of multiple processor cores on the same chip. The efficiency and the concurrency prevent the processors from stalling due to a lack of instructions or data. Processor stalling can reduce or eliminate any performance enhancement that was achieved. Memory semantics must be maintained across all cores in the system so that the contents of memory do not become corrupted. Further, memory semantics enable each core to operate on the most recent data, even if the data was updated by another core in the system. Thus, highly efficient memory system designs have become critical techniques for increasing processor performance.

To address the continued need for increased computational performance, a parallel architecture with compute slices and memory dependence prediction is disclosed. A program is compiled and is divided into slice tasks. Slice tasks comprise code sequences of diverse sizes which include at least one load instruction. A control unit within a processing unit can allocate any number of slice tasks to compute slices within the processing unit. The allocation is based on one slice task at a time per compute slice. The control unit can allocate a first slice task, which can be a predecessor task running non-speculatively. Other slice tasks can be allocated by the control unit and can be executed speculatively. The control unit can allocate a first slice task to a first compute slice pointed to by a pointer such as a head pointer. The first compute slice can execute the first slice task. The first slice task includes a load instruction. The load instruction includes a target address from which the load data is to be obtained. A prediction regarding whether the load instruction will alias with a previous store instruction can be made. The previous store instruction executes on a previous compute slice. The predicting can be based on an entry within a global aliasing table (GAT). The GAT can be used to detect load instructions and store instructions that target the same memory address. The entries in the GAT further include a slice offset associated with each store instruction. The slice offset indicates a number of compute slices that separate the compute slice executing the load instruction and the compute slice executing the previous store instruction. Using the prediction based on the GAT, the load instruction is stalled until the previous store instruction completes execution. Once the previous store instruction completes execution, the load instruction is allowed to execute.

Each compute slice is coupled to a successor compute slice and a predecessor compute slice by a barrier register set. The coupling can result in a ring configuration. The coupling of the compute slices enables data communication between compute slices. For example, a current compute slice can be coupled to an immediately succeeding compute slice by a current barrier register set. The current barrier register set provides unidirectional communication from the current compute slice to the successor compute slice. Thus, the first compute slice can write to the first barrier register set, and the successor compute slice can read from the first barrier register set. Pointers, such as a head pointer and a tail pointer, are used to determine how slice tasks are assigned and controlled by the control unit. The pointers can be part of the internal control unit state. The pointers can be initialized pointers such that a head pointer points to the first compute slice, and a tail pointer points to a second compute slice. The tail pointer can point to a subsequent compute slice in the plurality of compute slices. The head pointer can point to a slice task that is executing non-speculatively and the tail pointer can point to a slice task that is executing speculatively. The compute slice that is executing non-speculatively is known to be part of the executed program. In a usage example, the tail pointer indicates which compute slice was the last to receive a slice task by the control unit. A head slice can be a compute slice which is pointed to by the head pointer. Likewise, a tail slice can be a compute slice pointed to by a tail pointer. A compute slice can execute speculatively if it is not the head slice. The control unit distributes a slice task to a compute slice succeeding the tail slice. After distribution, the control unit can update the tail slice to point to the succeeding compute slice for further distribution of slice tasks to downstream compute slices. The head pointer and the tail pointer can be updated, by the control unit, based on slice task execution status, branch operation outcome determination, and so on. Executing multiple slice tasks on two or more compute slices enables parallelized operations, thus increasing performance.

Programs executed by the compute slices within the processing unit can be associated with a wide range of applications. The applications can be based on data manipulation, such as image, video, or audio processing applications; AI and machine learning applications; business applications; data processing and analysis; and so on. The slice tasks that are executed can perform a variety of operations including arithmetic operations, shift operations, logical operations including Boolean operations, vector or matrix operations, tensor operations, and the like. The slice tasks can be executed based on branch prediction, operation precedence, priority, coding order, amount of parallelization, data flow, data availability, compute slice availability, communication channel availability, and so on. Slice tasks that comprise a compiled program are generated by a compiler. The compiler can include a general-purpose compiler, a hardware description-based compiler, a compiler written or “tuned” for the specific number of compute slices in the processor unit, a constraint-based compiler, a satisfiability-based compiler (SAT solver), and so on. Control is provided to the hardware by the control unit which allocates slice tasks to compute slices. Once issued, the slice tasks can execute independently from the control unit and other compute slices until they are either halted by the control unit, indicate an exception, finish executing, etc. In this way, a compiled task can be executed by the processing unit.

The compute slices within the processing unit can be implemented with central processing units (CPUs), graphics processing units (GPUs), application specific integrated circuits (ASICs), field programmable gate arrays (FPGAs), processing cores, or other processing components or combinations of processing components. The compute slices can include heterogeneous processors, homogeneous processors, processor cores within an integrated circuit or chip, etc. The compute slices can be coupled to local storage, which can include load-store units, local memory elements, register files, cache storage, etc. The cache, which can include a hierarchical cache such as an L1, L2, and L3 cache, can be used for storing data such as intermediate results, compute slice operations, and the like. Any level of cache (e.g., L1, L2, L3, etc.) can be shared by two or more compute slices. The local storage can be coherent.

Checking memory operations is enabled by accessing a processing unit comprising a plurality of compute slices, a control unit, and a global aliasing table (GAT). The processing unit can further include a memory system. Each compute slice within the plurality of compute slices includes at least one execution unit. The execution unit can include multicycle elements for multiplication, division, and square root computations; arithmetic logic units (ALUs); storage elements; scratchpads; and other components. The components can communicate among themselves to exchange data, signals, and so on. Each compute slice is known to a compiler and is coupled to a successor (next) compute slice and a predecessor (previous) compute slice. The control unit can distribute a first slice task to a first compute slice. The first slice task can include a set of instructions that will be executed by a first compute slice. A first compute slice in the plurality of compute slices executes a first slice task. The first slice task includes a load instruction, which is associated with a target address. The load instruction is predicted to alias with a previous store instruction. The aliasing can indicate that the load instruction and the previous store instruction are associated with the same target address. The target address can include a memory address, where the memory address can include an address associated with a local memory, a cache memory, a system memory, etc. The previous store instruction executes on a previous compute slice among the plurality of compute slices. The previous store instruction can be associated with a slice task that is executing non-speculatively. The predicting is based on the GAT. The load instruction is stalled until the previous store instruction completes execution on the previous compute slice. The completion of the previous store instruction can avoid a memory access hazard in which invalid data could be loaded in error. The stalling can be enabled by the first compute slice. The stalling can be controlled by the control unit. The load instruction is allowed to execute. The allowing a load instruction execution can occur after completion of the previous store instruction.

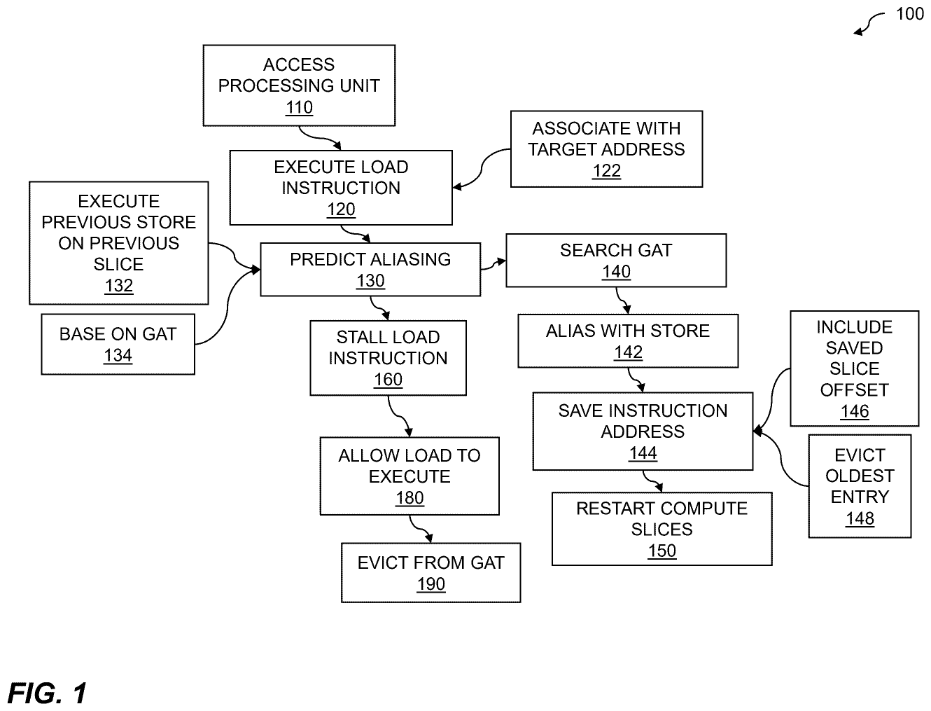

FIG. 1 is a flow diagram for memory dependence prediction in a parallel architecture with compute slices. Compute slices within a processing unit can be issued blocks of code, called slice tasks, for execution. The processing unit can include any number of compute slices. The slice tasks can be associated with a compiled program. The compiled program, when executed, can perform a variety of operations associated with data processing. The processing unit can include elements such as compute slices, a control unit, and a global aliasing table (GAT). The processing unit can also include barrier register sets and a memory system. The processing unit can include further elements such as ALUs, memory management units (MMUs), GPUs, multicycle elements (MEMs), and so on. The operations executed by the processing unit can accomplish a variety of processing objectives such as application processing, data manipulation, data analysis, modeling and simulation, and so on. The operations can accomplish artificial intelligence (AI) applications such as machine learning. The operations can manipulate a variety of data types including integer, real, floating point, and character data types; vectors, matrices, and arrays; tensors; etc. To maintain the integrity of the program that is executing, all memory operations are committed according to the memory model. In a usage example, all memory instructions are committed in program order. As a program executes, a load can alias with a previous store instruction. This aliasing can produce incorrect program results when the load (which occurs after the store in program order) is speculatively executed before the store due to parallel slice execution. To avoid this scenario, the instruction address of the load and the instruction address of the store can be stored in the GAT, along with a slice offset. Later in the program, load instructions associated with a slice task can be checked against previously executed memory instructions that include loads and stores. The checking can be performed using the GAT to predict aliasing of a load instruction with a previous store instruction. The previous store instruction can be associated with a previous slice task. When a load target address aliases with a previous store instruction, the load instruction can be stalled until the store instruction completes execution. Although the stalling can delay the load instruction and, by extension, the slice task that contains the load instruction, the stalling obviates the need to flush the slice task containing the load instruction, and subsequent slice tasks, from the compute slices. Thus, processing efficiencies can be obtained, resulting in overall faster processing.

The flow 100 includes accessing 110 a processing unit comprising a plurality of compute slices, a control unit, and a global aliasing table (GAT). The processing unit and its comprising elements can be included in one or more integrated circuits (ICs). In embodiments, each compute slice within the plurality of compute slices includes at least one execution unit, is known to a compiler, and is coupled to a successor compute slice and a predecessor compute slice. The processing unit can further include a memory system. The compute slices within the processing unit can be implemented with central processing units (CPUs), graphics processing units (GPUs), application specific integrated circuits (ASICs), field programmable gate arrays (FPGAs), processing cores, or other processing components or combinations of processing components. The compute slices can include heterogeneous processors, homogeneous processors, processor cores within an integrated circuit or chip, etc. The compute slices within the processing unit can have identical functionality. The compute slices within the processing unit can have different functionality. The compute slices can be coupled to a barrier register set which can enable data transfer between compute slices. The compute slices can share a variety of computational resources within the processing unit. The plurality of compute slices can be coupled in a ring configuration. The ring configuration can include barrier registers which are coupled between compute slices. Other topologies, such as a matrix topology, are possible. The topology can be selected for a specific application such as machine learning. A topology for machine learning can include supervised learning, unsupervised learning, reinforcement learning, and other machine learning topologies. A topology for machine learning can include an artificial neural network topology.

The execution units within the compute slices can include multicycle elements for multiplication, division, and square root computations; arithmetic logic units (ALUs); storage elements; scratchpads; and other components. The components can communicate among themselves to exchange data, signals, and so on. In embodiments, more than one processing unit can be accessed. Two or more processing units can be co-located on an integrated circuit or chip, on multiple chips, and the like. In a configuration example, two or more processing units can be stacked to form a three-dimensional (3D) configuration. The memory system can include local memory elements, register files, cache storage, etc. The cache, which can include a hierarchical cache, can be used for storing data such as intermediate results, compute slice operations, and the like. The cache can include an L1 cache, L2 cache, L3 cache, and so on. Any level of cache can be shared by two or more compute slices. In embodiments, the cache architecture is write-through. The cache architecture can include a write-back architecture. In another architectural example, the hierarchical cache is coherent. The control unit can be coupled to each of the compute slices within the processor unit. The control unit and the compute slices can communicate status information about the compute slice and execution status of a slice task. In embodiments, the status information can include bits which determine the state of the compute slice, such as idle, executing, holding, done, and so on.

A compiled program is divided into slice tasks. Slice tasks comprise code sequences of diverse sizes. The slice tasks can include at least one load instruction. A control unit can allocate any number of slice tasks to compute slices, one slice task per compute slice. The control unit can allocate a first slice task, which can be a predecessor slice task that can run non-speculatively while all other successive slice tasks run speculatively. The control unit can allocate a second slice task to a second compute slice, which can execute on the next immediate successor compute slice while the first slice task is executing. The second slice task can be executed speculatively. Successor slice tasks can be allocated by the control unit at any time during execution of the compiled program.

Each compute slice is coupled to a successor compute slice and a predecessor compute slice by a barrier register set. The coupling can result in a ring configuration. The coupling of the compute slices enables data communication between compute slices. For example, a current compute slice can be coupled to an immediately succeeding compute slice by a current barrier register set. The current barrier register set provides unidirectional communication from the current compute slice to the successor compute slice. Thus, the current compute slice can write to the current barrier register set and the successor compute slice can read from the current barrier register set. Pointers are used to determine how slice tasks are assigned and controlled by the control unit. The pointers can be part of the internal control unit state. The pointers can include a head pointer and a tail pointer. In a usage example, the head pointer indicates which compute slice is executing non-speculatively, and therefore is known to be part of the executed program. In another usage example, the tail pointer indicates which compute slice was the last to receive a slice task by the control unit. A head slice can be a compute slice which is pointed to by the head pointer. Likewise, a tail slice can be a compute slice pointed to by a tail pointer. A compute slice can execute speculatively if it is not the head slice. The control unit can distribute a slice task to a compute slice succeeding the tail slice. After distribution, the control unit can update the tail slice to point to the succeeding compute slice for further distribution of slice tasks to downstream compute slices. The head pointer and the tail pointer point to the same compute slice. The head pointer and the tail pointer can be updated, by the control unit, based on slice task execution status, branch operation outcome determination, and so on. Executing multiple slice tasks on two or more compute slices enables parallelized operations, increasing performance.

The control unit can distribute slice tasks to one or more compute slices within the plurality of compute slices. A slice task can include one or more instructions such as arithmetic and logical instructions, memory access instructions, and so on. A second compute slice can be allotted a slice task. The second compute slice can be coupled to a barrier register set, where the barrier register set is further coupled to the first compute slice. A head pointer and a tail pointer can be initialized. The head pointer can point to the first compute slice, and a tail pointer points to the second compute slice. Because the processing unit includes multiple compute slices, slice tasks can be executed in parallel. A slice task can be executed non-speculatively, while other slice tasks can be executed speculatively. In a usage example, the head pointer can point to a slice task that is running non-speculatively, and the tail pointer can point to a slice task that is executing speculatively.

As described earlier, pointers are used to determine how slice tasks are assigned and controlled by the control unit. The pointers can be part of the internal control unit state. The pointers can include a head pointer and a tail pointer. The head pointer can indicate which compute slice is executing non-speculatively and therefore is known to be part of the compiled program. The tail pointer can indicate which compute slice was the last to receive a slice task by the control unit. A head slice is a compute slice which is pointed to by the head pointer within the control unit. Likewise, a tail slice is a compute slice pointed to by a tail pointer within the control unit. In embodiments, a compute slice executes speculatively if it is not the head slice. Thus, the distributing can result in a compute slice executing a slice task speculatively. The control unit can distribute a slice task to a compute slice which succeeds the tail slice. After distribution, the control unit can update the tail pointer to point to the next succeeding compute slice for further distribution of slice tasks to downstream compute slices.

The flow 100 includes executing 120, by a first compute slice among the plurality of compute slices, a load instruction. The first compute slice can include one or more instructions, where the instructions can include arithmetic instructions, logical instructions, control instructions, branch instructions, memory access instructions, and so on. In embodiments, the load instruction is associated with a target address 122. The target address can include a memory address. The memory with which the address is associated can include a local memory, a single-level cache or a multi-level cache, a shared memory, a system memory, and the like. The memory access instructions can include store instructions and load instructions. The load instruction included in the first slice task can access an address in storage such as a memory system. In a usage example, the load instruction can include a 64-bit aligned address.

The flow 100 includes predicting 130 that the load instruction will alias with a previous store instruction. The predicting can be based on a percentage, a probability, a binary decision such as likely or unlikely, and so on. The predicting can be based on loops or repetitions within code. The predicting can be based on previous aliasing of a load instruction to a previous store instruction. For example, a load executing as part of code running a compute slice can alias with a previous store that is executing as part of code running on an upstream compute slice. The aliasing can be detected by the memory subsystem. As described previously, this aliasing can produce incorrect program results when the load (which occurs after the store in program order) is speculatively executed before the store due to parallel slice execution. When the aliasing is detected, the compute slice that is executing the load instruction can be cancelled since it was executing speculatively, and thus the load most likely received incorrect data. In addition, all compute slices that are executing after the compute slice executing the load instruction can be cancelled since they too were executed speculatively. This can have a substantial impact on performance. To avoid this situation in the future, the address of the load instruction and the address of the store instruction can be saved in the GAT, along with a slice offset. In the future, this data can be used to predict a future aliasing of the load instruction and store instruction. When a prediction is made, the compute slice that is executing the load instruction can be stalled until the store instruction is executed, avoiding the performance penalty associated with cancelling compute slices. In embodiments, the previous store instruction executes 132 on a previous compute slice among the plurality of compute slices. The previous compute slice can be an immediate predecessor compute slice, a compute slice farther upstream from the immediate predecessor compute slice, and so on. In embodiments, the predicting is based 134 on the GAT. The GAT can include one or more entries, where an entry can include an address of a load instruction and load addresses for one or more previous store instructions. In other embodiments, the predicting includes finding, in the GAT, an entry which includes the previous store instruction that was associated with the load instruction.

In the flow 100, the predicting includes searching 140, in the GAT, for an entry which includes the load instruction. The search of the GAT can include a bitwise search, a bytewise search, a content-addressable search, and so on. In embodiments, the entry which includes the load instruction is not found. A negative search result, a result in which an entry which includes the load instruction is not found, can indicate that the load instruction may not or does not target an address that is also targeted by a previous store instruction. A positive search result, a result in which an entry which includes the load instruction is found, can indicate a dependency between the load instruction and the previous store instruction. In embodiments, the load instruction aliased 142 with the previous store instruction. Further embodiments include saving 144, in an entry of the GAT, an instruction address of the load instruction. The instruction address can be used to identify the location, order, and so on of the load instruction so that execution of the load instruction can be controlled. In further embodiments, the instruction address of the load instruction is associated, in the entry of the GAT, with an instruction address of the previous store instruction. The address of the store instruction can be used to determine whether the store instruction has been executed, delayed, halted, and the like. More than one store instruction address can be stored. In embodiments, the saving can include a second previous store instruction. The second previous store instruction can include an instruction associated with the same slice task as the (first) previous store instruction, or a different slice task.

In the flow 100, the saving includes a saved slice offset 146. The saved slice offset can be calculated. In embodiments, the saved slice offset comprises X+1, where X is a number of compute slices between the first compute slice and the previous compute slice. X can include an integer value. In a usage example, the previous store instruction is executed by the immediate predecessor compute slice to the first. Thus, the offset is calculated as 0 (since there are no intermediate compute slices)+1=1. In a second usage example, there is one intermediate compute slice between the first compute slice and the predecessor compute slice. Thus, the offset is calculated as 1 intermediate compute slice+1=2. In embodiments, the saving includes evicting, from the GAT, an oldest entry 148, wherein the GAT is full. The evicting can also be based on other eviction techniques such as least-recently-used (LRU), least-frequently-used (LFU), first-in-first-out (FIFO), random replacement, etc. Embodiments include restarting 150 one or more compute slices among the plurality of compute slices. The restarting can be accomplished by the compute slice on which the slice task is executing. The restarting can be controlled by the control unit. In further embodiments, the restarting includes the first compute slice, a tail slice, and every compute slice between the first compute slice and the tail slice. The restarting can reenable slice task execution once needed data has been provided by the previous store instruction.

The flow 100 includes stalling 160 the load instruction until the previous store instruction completes execution on the previous compute slice. The stalling can be accomplished by a control signal, a flag, a semaphore, a control code, and so on. The stalling can be controlled by the control unit. The stalling can suspend execution of the load instruction. The stalling can be based on a number of cycles such as execution cycles. The stalling can be controlled acyclically. Embodiments include stalling, by the first compute slice, the load instruction, until the previous compute slice completes execution of the previous store instruction. The flow 100 includes allowing 180 the load instruction to execute. The allowing can be based on a signal, a flag, etc. The allowing can be enabled by the compute slice on which the load instruction with the slice task is executing. The allowing can be enabled by the control unit.

The flow 100 further includes evicting 190 an entry of the GAT, wherein the load instruction and the previous store instruction did not alias. If the prediction is incorrect, then the load instruction and the store instruction will not alias. Once it is determined that the load and the store do not alias, the prediction within the GAT can be evicted so that an incorrect prediction is not made in the future. To evict the entry, the address of the store instruction can be cancelled, removed, deleted, invalidated, etc. If there is only one store instruction associated with the load instruction in the GAT, then the entire entry can be removed, deleted, invalidated, etc.

In embodiments, the predicting, the stalling, and the allowing can include a second previous store instruction. The second previous store instruction can be associated with a slice task allocated to an upstream compute slice. In embodiments, the second previous store instruction executes on the previous compute slice among the plurality of compute slices. The previous compute slice can include the same previous compute slice associated with the (first) previous store instruction, or with a different previous compute slice. In embodiments, the slice offset is associated, in the GAT, with the second previous store instruction. In other embodiments, the second previous store instruction executes on a second previous compute slice among the plurality of compute slices. In embodiments, the second previous store instruction is associated, in the GAT, with a second slice offset. The second slice offset can include an integer offset value. In embodiments, the second slice offset comprises Z+1. The calculation of Z can be similar to the determination of X discussed previously. In embodiments, Z is a number of compute slices between the first compute slice and the second previous compute slice. In a usage example, the entry in the GAT associated with the load instruction includes the addresses of two previous store instructions. The slice offset associated with each previous store instruction can be different. Thus, the predicting that the load instruction can alias with the previous store instructions, can be based on which store instruction is more distant or is nearer, and so on.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

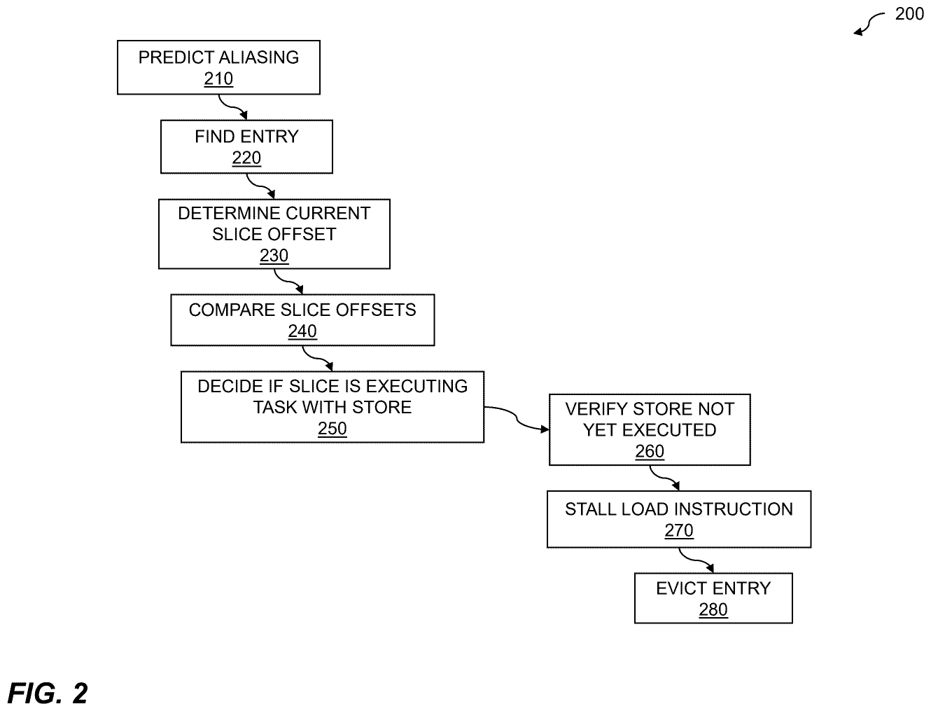

FIG. 2 is a flow diagram for predicting aliasing. As described above and throughout, the predicting aliasing, which can be based on contents of a global aliasing table (GAT), can be used to control execution of load instructions that can alias with previous store instructions. While previous store instructions within a same slice task as the load instruction can be handled by a local memory disambiguation unit (LMDU) associated with a compute slice that is executing the slice task, aliasing between the load instruction and previous store instructions that are executed by other compute slices cannot be handled locally. Instead, the GAT can be searched for a saved entry that includes the address of the load instruction. The GAT can further include an address of one or more store instructions that can reference the same target address as the load instruction. Each store instruction can be saved with a slice offset. The slice offset can include a number of compute slices between the compute slice executing the load instruction and the compute slice executing the store instruction. The GAT entry associated with the load instruction and the one or more store instructions can be used to predict aliasing between the load instruction and the one or more store instructions. The predicting aliasing enables memory dependence prediction in a parallel architecture with compute slices.

A processing unit comprising a plurality of compute slices, a control unit, and a global aliasing table (GAT) is accessed. Each compute slice within the plurality of compute slices includes at least one execution unit, is known to a compiler, and is coupled to a successor compute slice and a predecessor compute slice. A first compute slice among the plurality of compute slices executes a load instruction. The load instruction is associated with a target address. The load instruction is predicted that it will alias with a previous store instruction. The previous store instruction executes on a previous compute slice among the plurality of compute slices. The predicting is based on the GAT. The load instruction is stalled until the previous store instruction completes execution on the previous compute slice. The load instruction is allowed to execute.

The flow 200 includes predicting 210 that the load instruction will alias with a previous store instruction. The predicting can be based on a binary factor such as likely or unlikely, a probability, a percentage, and so on. In embodiments, the previous store instruction executes on a previous compute slice among the plurality of compute slices. The previous compute slice can be executing a slice task different from the slice task with which the load instruction can be associated. In embodiments, the predicting is based on the GAT. The predicting can be based on finding contents within the GAT. The flow 200 includes finding 220, in the GAT, an entry which includes the previous store instruction that was associated with the load instruction. The finding can be based on a search technique, a content-addressable technique, a matching technique, and so on. The finding can be based on comparing the load address to each entry within the GAT. The flow 200 includes determining 230 a current slice offset. The current slice offset can be based on a number of compute slices. In embodiments, the current slice offset comprises Y+1. Y+1 is computed where Y is a number of compute slices between the first compute slice and the previous compute slice. In a usage example, the previous compute slice is an immediate predecessor of the first compute slice. In this example, there are no compute slices between the first compute slice and the previous compute slice, so Y=0. Thus, the slice offset is Y+1=0+1=1. In another usage example, there are two compute slices between the first compute slice and the previous compute slice. In this latter example, Y=2, so the slice offset is computed as Y+1=2+1=3.

The flow 200 includes comparing 240 the current slice offset to a saved slice offset. The comparing can be based on a bit-wise comparison, a byte-wise comparison, and so on. In embodiments, the current slice offset and the saved slice offset are equal. Based on the current slice offset and the slice offset being equal, an aliasing prediction can be made. The aliasing prediction can include predicting that the load instruction will alias with the previous store instruction. The flow 200 includes deciding 250, by the control unit, if the previous compute slice is executing a slice task that includes the previous store instruction. Recall that the control unit can control all compute slices within the processing unit. The control unit can issue one or more slice tasks to one or more compute slices, can control execution of the compute slices, and so on. Based on the comparison described above, between the current slice offset and the saved slice offset, the control unit can determine which slice tasks have been distributed to compute slices. If the previous slice task is loaded onto a compute slice, then the control unit can decide whether the previous slice task is executing. This can be accomplished in parallel to the comparison of the current slice offset and the saved slice offset, as described above. The flow 200 includes verifying 260 that the previous compute slice has not yet executed the previous store instruction. The verifying that the previous store instruction has been executed can be based on a counter such as an instruction counter, a program counter, etc. The verifying can be based on the control unit. The verifying can include inquiring of the compute slice running the code slice that includes the previous store instruction. If the store instruction has been executed, then the load instruction can proceed. If the store instruction has not yet been executed, then the store instruction must wait for valid data to be stored. Otherwise, the load instruction could load stale data, invalid data, and so on.

The flow 200 includes stalling 270, by the first compute slice, the load instruction, until the previous compute slice completes execution of the previous store instruction. The stalling can avoid a memory access hazard, a race condition, etc. The stalling can be based on a number of cycles such as processing cycles. The stalling can be initiated by a control signal, a flag, a code, or other indication. The stalling can be accomplished by the first compute slice. The stalling can be controlled by the control unit. The first compute slice can be directed to initiate the stall by the control unit.

The flow 200 includes evicting 280 an entry of the GAT wherein the load instruction and the previous store instruction did not alias. Once the prediction has been made and the load instruction has been stalled, the memory system can determine if the load instruction and the previous store instruction actually aliased. If the load and the previous store did alias, no further action is required, and the load and the store can remain in the GAT. This ensures that in the future, when the same situation occurs, the load instruction and the previous store instruction will again be predicted to alias. However, if the memory system detects that the load and the store did not alias (e.g., the prediction was incorrect), then the entry can be evicted from the GAT. The evicting can include cancelling, removing, deleting, invalidating, etc. the address of the previous store instruction. If there is only one previous store instruction associated with the load instruction in the GAT, the entire entry in the GAT can be removed, deleted, invalidated, etc.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

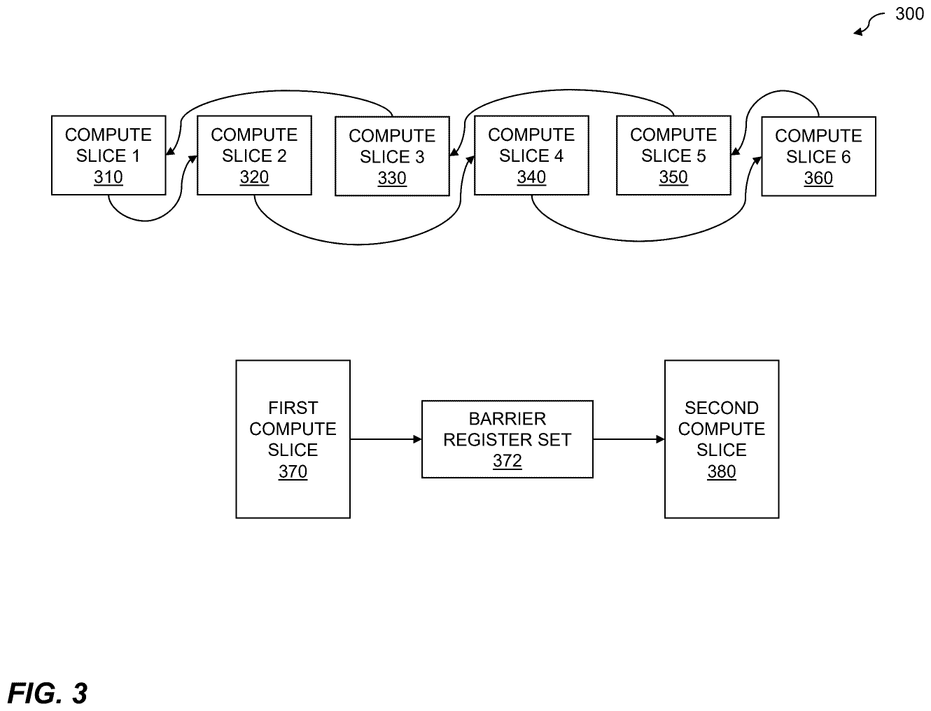

FIG. 3 illustrates a system block diagram for a ring configuration of compute slices. Described previously and throughout, a program such as an application program can be compiled, and a processing unit can be used to process the compiled program. The program can be associated with processing applications such as image processing, audio processing, and natural language processing applications. The processing can be associated with artificial intelligence applications such as machine learning, deep learning, and so on. The processing unit can include various elements. Among other elements such as a control unit, the processing unit can comprise compute slices that are coupled to barrier register sets. A barrier register set can be coupled between two compute slices to enable unidirectional communication between the two compute slices. The barrier register set can be used to hold data for processing by a compute slice, can receive committed effects such as data and branch decisions from the compute slices, and so on. Pointers such as a head pointer and a tail pointer can be used to direct blocks of code issued for execution by a control unit to the compute slices. The compute slices and the barrier register sets can be coupled in a ring configuration. The ring configuration of the compute slices and the barrier register sets enable memory dependence prediction in a parallel architecture with compute slices. A processing unit is accessed that comprises a plurality of compute slices, a control unit, and a global aliasing table (GAT), wherein each compute slice within the plurality of compute slices includes at least one execution unit, is known to a compiler, and is coupled to a successor compute slice and a predecessor compute slice. A first compute slice among the plurality of compute slices executes a load instruction, wherein the load instruction is associated with a target address. The load instruction is predicted to alias with a previous store instruction, wherein the previous store instruction executes on a previous compute slice among the plurality of compute slices, and wherein the predicting is based on the GAT. The load instruction is stalled until the previous store instruction completes execution on the previous compute slice. The load instruction is allowed to execute.

A ring configuration of compute slices is shown in the illustration 300. The compute slices within the ring configuration can include compute slice 1 310, compute slice 2 320, compute slice 3 330, compute slice 4 340, compute slice 5 350, compute slice 6 360, and so on. While six compute slices are shown, the ring of compute slices can also comprise more or fewer compute slices. The ring configuration can be accomplished using an integrated circuit or chip, a plurality of compute slice cores, a configurable chip, and the like. The ring configuration can be based on a regularized circuit layout, equalized interconnect lengths, and so on. A compute slice can be coupled to a second slice. A first compute slice 370 can be coupled to a second compute slice 380 using a barrier register set 372. The barrier register set can include a register set within a plurality of barrier register sets. Each compute slice of the illustration 300 can be coupled to a load-store unit (not shown). The load-store unit can handle data and instruction transfers between the compute slices and a memory system. Further, each compute slice can be coupled to a control unit (not shown). The control unit can enable loading and execution of slice tasks, loading and storing of data in barrier registers, etc.

Discussed previously, each compute slice can independently execute a block of code called a slice task. The slice tasks that can be associated with the compute slices can be associated with a compiled program. The execution of the slice tasks can be controlled by a local program counter associated with each compute slice. Communication between a slice and its immediate neighbors, such as a predecessor compute slice and a successor compute slice, is accomplished using a barrier register set. Recall that a control unit that can control the compute slices can ensure that slice task order is issued in one direction such as from left to right. As a result, a compute slice is not required to write to a predecessor compute slice, nor to read from a successor compute slice. In a usage example, the first compute slice can only write to the barrier register and the second compute slice can only read from the barrier register. This architectural technique can ensure that a compute slice that requires input data from a predecessor compute slice can read valid data. That is, the first compute slice generates data, branch decisions, etc., and writes this information to the input of the barrier register while the output of the register remains unchanged. The data being read at the output of the barrier register will remain valid while the second compute slice is processing data. The results from the first compute slice are not committed until after the first compute slice has completed execution and the second compute slice has obtained its data. The committing is performed by the control unit. This technique eliminates a race condition such as a write-before-read race condition.

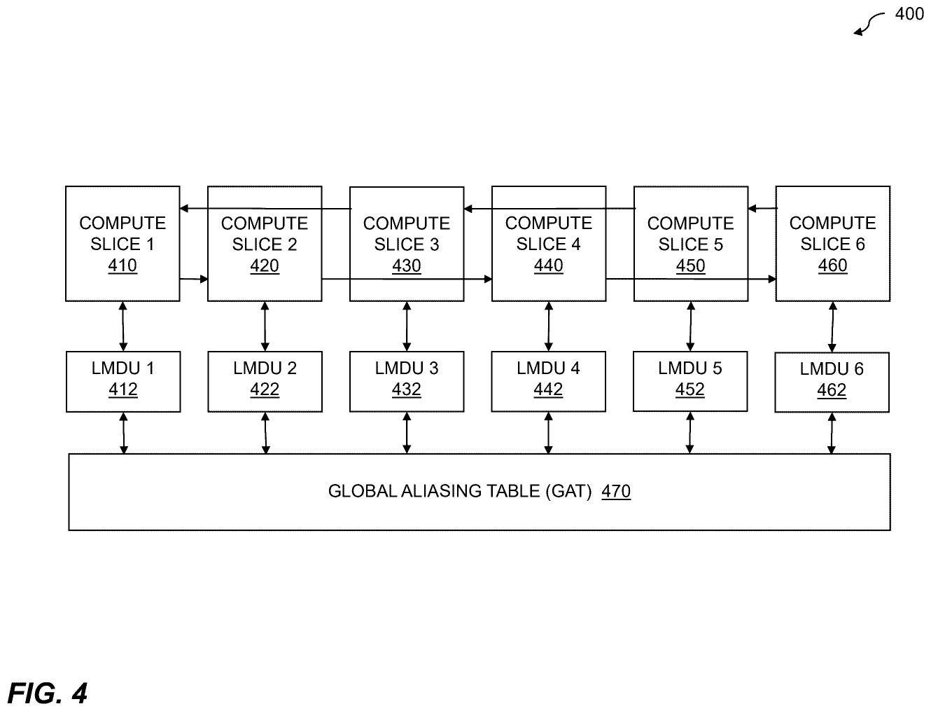

FIG. 4 is a block diagram for a ring configuration of compute slices and local memory disambiguation units (LMDUs). The local memory disambiguation units can be elements within one or more load-store units (LSUs). The LMDUs can each be coupled to a global memory aliasing table (GAT). Described previously and throughout, a processing unit can be used to execute a compiled program. The compiled program can be associated with processing applications such as image processing, audio processing, and natural language processing applications. The processing can be associated with artificial intelligence applications such as machine learning. The processing unit can include various elements such as compute slices, a control unit, and a global aliasing table (GAT).

Each compute slice can independently execute a block of code called a slice task. The slice tasks that can be assigned to the compute slices can be associated with the compiled program. The execution of the slice tasks can be controlled by a local program counter associated with each compute slice. Communication between a compute slice and its immediate neighbors, such as a predecessor compute slice and a successor compute slice, is accomplished using a barrier register set. A current compute slice is not required to write to a predecessor compute slice, nor to read from a successor compute slice.

The ring configuration of compute slices and local memory disambiguation units coupled to a global memory disambiguation unit enable memory dependence prediction in a parallel architecture with compute slices. A processing unit is accessed, comprising a plurality of compute slices, a control unit, and a global aliasing table (GAT). Each compute slice within the plurality of compute slices includes at least one execution unit. Each compute slice is coupled to a successor compute slice and a predecessor compute slice. The coupling between compute slices can be accomplished using a barrier register set. Each compute slice within the plurality of compute slices is coupled to an LMDU in the plurality of LMDUs, and each LMDU in the plurality of LMDUs is coupled to the GAT. A first compute slice among the plurality of compute slices executes a first slice task. The first slice task includes a load instruction, and the load instruction is associated with a target address. The first compute slice can issue the load instruction to a first LMDU within the first compute slice. The LMDU can be used to detect an alias to an address accessed by a previous store instruction with the slice task. The load instruction is predicted that it will alias with a previous store instruction. Here, the previous store instruction executes on a previous compute slice among the plurality of compute slices. In order to make such a prediction, the predicting is based on the GAT. The load instruction is stalled until the previous store instruction completes execution on the previous compute slice. The load instruction can be associated with a slice task that is executed speculatively. The previous store instruction executing on the previous compute slice can be running non-speculatively. The stalling can be used to enable loading of valid data, thereby avoiding a potential memory access race condition. When the previous store instruction completes, the load instruction can execute.

A ring configuration of compute slices is shown in the block diagram 400. The compute slices within the ring configuration can include compute slice 1 410, compute slice 2 420, compute slice 3 430, compute slice 4 440, compute slice 5 450, compute slice 6 460, and so on. While six compute slices are shown, the ring of compute slices can also comprise more or fewer compute slices. The compute slice ring configuration can be accomplished using an integrated circuit or chip, a plurality of compute slice cores, a configurable chip such as an FPGA or ASIC, and the like. The ring configuration can be based on a regularized circuit layout, equalized interconnect lengths, etc. Each compute slice, such as compute slice 3 430, can be coupled to a successor compute slice, such as compute slice 1 410, and a predecessor compute slice, such as compute slice 5 450. The coupling can include a barrier register set such as a barrier register set described previously. In a usage example, compute slice 3 430 can only write to the barrier register, and compute slice 1 410 can only read from the same barrier register. This architectural technique can ensure that a compute slice that requires input data from a predecessor compute slice can read valid data. That is, the current compute slice generates data, branch decisions, etc., and writes the generated data and branch decision information to the input of the barrier register while the output of the register remains unchanged. The data being read at the output of the barrier register will remain valid while the successor compute slice is processing data. The results from the first compute slice are not committed to the output of the barrier register set until after the current compute slice has completed execution, and the successor compute slice has obtained its data. The committing of data to the output of the barrier register set is performed by the control unit. This technique eliminates a race condition such as a write-before-read race condition.

Each of the compute slices can include at least one LMDU from a plurality of LMDUs. In the FIG. 400, compute slice 1 410 includes LMDU 1 412, compute slice 2 420 includes LMDU 2 422, compute slice 3 430 includes LMDU 3 432, compute slice 4 440 includes LMDU 4 442, compute slice 5 450 includes LMDU 5 452, and compute slice 6 460 includes LMDU 6 462. While six LSUs are shown, more or fewer LSUs can be included, according to the number of compute slices in the processor unit. A compute slice can execute a first slice task distributed by the control unit to the compute slice. A compute slice can issue a load instruction to a first LMDU, based on the compute slice executing the first slice task. The issuing can include saving load information associated with the load instruction in a memory operation table (MOT) (not shown) within the LMDU. The load instruction includes a target address. The LMDU can detect address aliasing between the load address and a store address of a previously issued store instruction, where the previously issued store instruction can include an instruction within the slice task. The detecting address aliasing can be accomplished using the MOT within the LMDU. The detecting aliasing can include aliasing between slice tasks. The load instruction can be predicted to alias with a previous store instruction that can execute on a previous compute slice among the plurality of compute slices. The prediction can be based on a previously executed slice task, on one or more previously executed store instructions associated with the previously executed slice task, and so on. In embodiments, the predicting is based on the GAT 470. Each LMDU within the plurality of LMDUs is coupled to the GAT. The GAT can be used to keep track of store instructions and load instructions that occur in a plurality of slice tasks, where one of the slice tasks can execute non-speculatively, and other slice tasks can execute speculatively. In embodiments, the predicting can include searching, in the GAT, for an entry which includes the load instruction, wherein the entry which includes the load instruction is not found. When the entry is not found in the GAT, the load instruction can execute since no previously executed store instruction is found to correspond to the target address of the load instruction. In other embodiments, the load instruction aliased with the previous store instruction. The load instruction can be stalled so that the load instruction waits until after the store instruction has completed.

Discussed previously, the predicting that the load instruction will alias to a previously stored instruction can be based on the GAT 470. Searching the GAT for an entry can succeed or fail depending on the contents of the GAT. Further embodiments include saving, in an entry of the GAT, an instruction address of the load instruction. The instruction address of the load instruction is associated, in the entry of the GAT, with an instruction address of the previous store instruction. More than one load instruction can alias to the previous store instruction. The load instructions can originate from more than one slice task. In embodiments, the saving can include a saved slice offset, wherein the saved slice offset comprises X+1, wherein X is a number of compute slices between the first compute slice and the previous compute slice. The predicting can further be based on the slice offset. In a usage example, the load instruction address and the compute slice offset value can be discovered to match a previously determined load instruction address and compute slice offset. Since the address and offset have occurred previously, the prediction may include predicting that the same set of slice tasks may be executing. More than one store instruction can be encountered. In embodiments, the saving can include a second previous store instruction. The second previous store instruction can be associated with the same slice task as the first save instruction or a different slice task. Since the GAT can include a number of entries such as 16, 32, 64 entries, and so on, the GAT can be filled. In embodiments, the saving can include evicting, from the GAT, an oldest entry, wherein the GAT is full. The evicting can be based on various eviction or replacement techniques such as first-in-last-out (FIFO), random replacement, least recently used (LRU), etc.

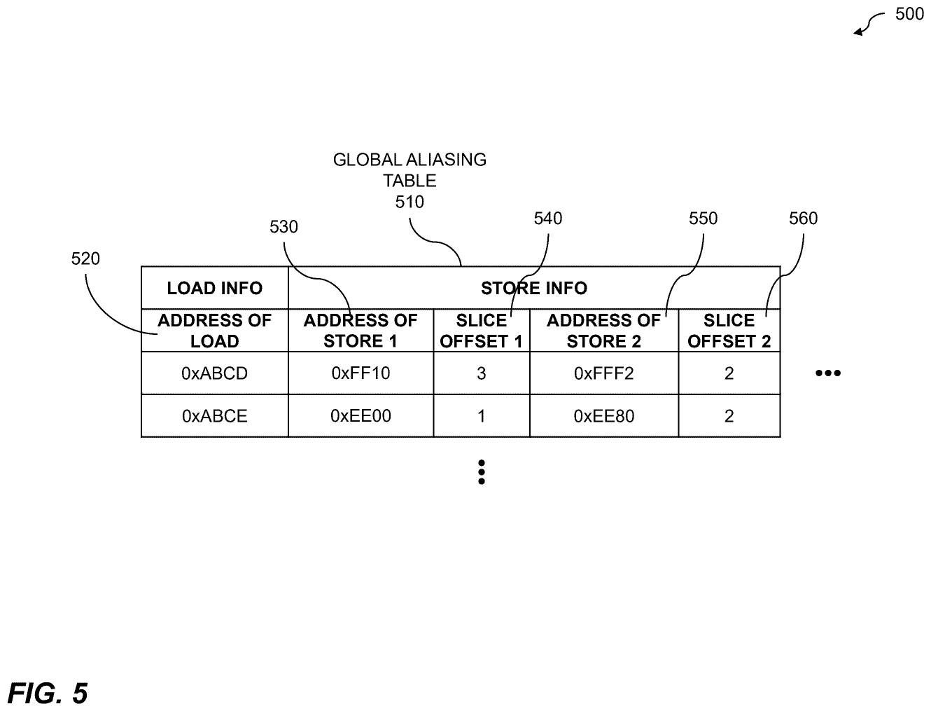

FIG. 5 is a diagram of a global aliasing table (GAT). Discussed previously and throughout, a load instruction can be predicted to alias with a previous store instruction. A local memory disambiguation unit (LMDU) associated with a compute slice can be used to determine that the load instruction aliases with a previous store instruction within a slice task. However, the load instruction can also be predicted to alias with a previous store instruction that executes on a previous compute slice. This cannot be predicted by an LMDU. Instead, the predicting can be based on the GAT. The predicting can be based on the memory system detecting that a speculative load would have been performed “too early.” “Too early” indicates that the load executed before an aliasing store instruction that is associated with a slice task executing on a predecessor compute slice. Since the load instruction that aliases with the previous store instruction requires the data stored by the store instruction, the load instruction can be stalled until the slice task on the previous compute slice produces the needed data. The load instruction can then be allowed to execute after completion of the store instruction. The global aliasing table enables memory dependence prediction in a parallel architecture with compute slices.

The diagram 500 shows a global memory operation table 510. The GAT can include an entry for a load instruction. An entry can be saved in the GAT comprising the address of the load instruction, where the instruction address of the load instruction can be associated, in the entry of the GAT, with an instruction address of a previous store instruction that aliased with the load instruction during execution of a program. The GAT can be searched for the load instruction address. The search for the load instruction address can result in the load instruction address being found or not being found. The load instruction being found can include one or more instruction addresses of one or more store instructions. The GAT can include two types of information, where the information includes load information and store information. Each type of information can include one or more fields. Table 1 below shows an example of information types and fields.

TABLE 1
Information types, field names, and field meanings.

| INFO TYPE | FIELD NAME | MEANING |
|---|---|---|
| LOAD | ADDRESS OF LOAD | Load Target Address |
| STORE | ADDRESS OF STORE 1 | First Store Target Address |
| | SLICE OFFSET 1 | First Compute Slice Offset |
| | ADDRESS OF STORE 2 | Second Store Target Address |
| | SLICE OFFSET 2 | Second Compute Slice Offset |

Each load instruction includes address information 520. The load instruction can include a load instruction within a slice task that is executing speculatively. The load address can include a target address in storage such as a memory. The memory can include a shared memory, a system memory, and so on. While information for two addresses is shown, other numbers of addresses can be included, where each address is unique. An address within the GAT can include a 64-bit address, a 32-bit address, or some other number of bits for the address. The load address information can include an address such as 0xABDC and 0xABCE. The load instruction can be determined to have aliased to a previous store operation. The previous store instruction can include a store instruction executed by a compute slice executing a slice task. The slice task can be executing speculatively or non-speculatively.

Note that a plurality of store operations can be stored in a row of the GAT corresponding to the target of the load instruction. The store information includes an address of a store instruction and a slice offset. In the example GAT, there are two store addresses and two slice offsets associated with each load address. While two store addresses and two slice offsets are shown for each address of a load, the number of store addresses can include one or more store instruction addresses. Each store instruction address can include 64 bits, 32 bits, or some other number of bits. The store instruction can alter the contents of the target address that aliases with the load address. The altering the contents can include changing one or more bits, one or more bytes, the entire contents, and the like. In the example GAT, the address of the load instruction 0xABCD can be associated with an address of store 1 530 0xFF10 with a slice offset 1 540 of 3 slices. The address of the load instruction 0xABCD can be further associated with an address of store 2 550 0xFF10 with a slice offset 2 560 of 2 slices. The example GAT can also include the address of the load instruction 0xABCE, associated with an address of store 1 0xEE00 with a slice offset 1 of 1 slice. The address of the load instruction 0xABCE can be further associated with an address of store 2 0xEE80 with a slice offset 2 of 2 slices.

Noted previously, the contents of the GAT can be used to predict that a given load instruction, such as a load instruction within a slice task that is executing speculatively, will again alias with a previous store instruction. The predicting can be used to stall the load instruction until a previous store instruction executes. By stalling the load instruction, and later allowing the load instruction to execute, the load instruction can be ensured to load proper data. The stalling and the restarting can prevent a memory access hazard or race condition such as a store-after-load race condition. Embodiments can include saving, in an entry of the GAT, an instruction address of the load instruction. The instruction address of the load instruction is associated, in the entry of the GAT, with an instruction address of the previous store instruction. Recall that the saving can include a slice offset. The slice offset can include a number of slices “ahead” of the compute slice with which the load instruction is associated. In embodiments, the saving can include a saved slice offset, wherein the saved slice offset comprises X+1, wherein X is a number of compute slices between the first compute slice and the previous compute slice.

The global aliasing table can include a quantity of entries. As aliased loads and stores are added to the GAT, the GAT can eventually become full. When the GAT is full, saving an instruction address in an entry of the GAT can fail. To enable saving the instruction address in an entry of the GAT, an entry in the GAT can be evicted. In embodiments, the saving can include evicting, from the GAT, an oldest entry, wherein the GAT is full. The evicting can also be based on other algorithms and techniques such as least-recently-used (LRU), least-frequently-used (LFU), first-in-first-out (FIFO), random replacement (RR), and so on.

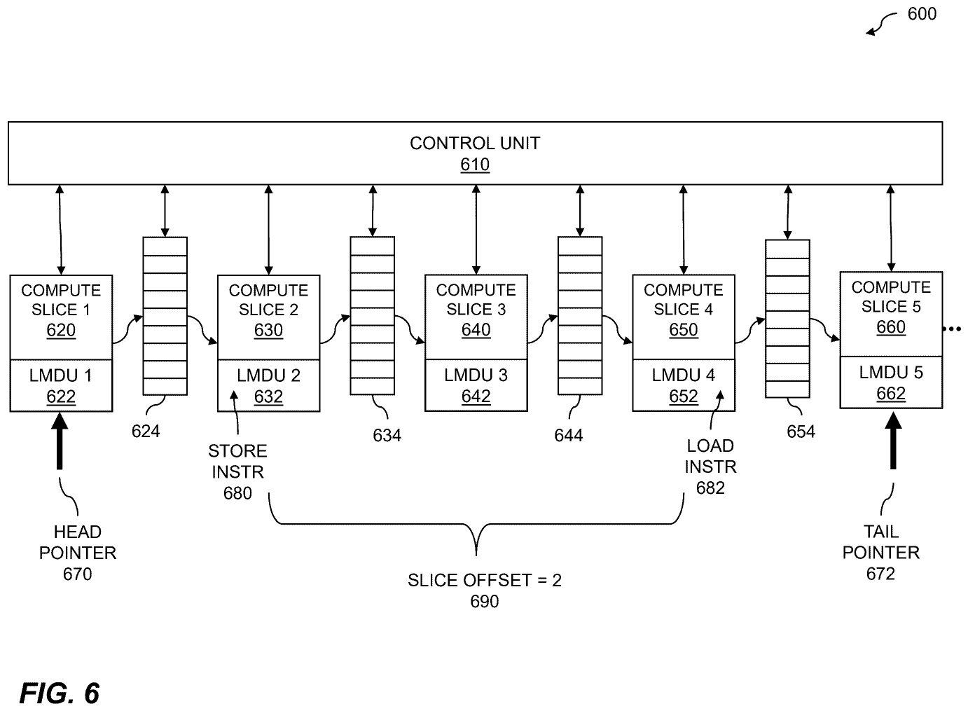

FIG. 6 is a block diagram for determining slice offset. A processing unit can include a plurality of elements that enable processing of diverse types of data. The processing unit can be used to process data for applications such as image processing, audio and speech processing, natural language processing, artificial intelligence and machine learning, and the like. The processing unit can include a variety of elements, where the elements include a plurality of compute slices; a control unit; and a global aliasing table (GAT). The processing unit can further include a memory system such as shared or system memory, busing, switching and networking, etc. In embodiments, each compute slice within the plurality of compute slices includes at least one execution unit. Each compute slice can be coupled to a local memory disambiguation unit (LMDU). The compute slices can obtain data for processing from storage. The data can be obtained from the memory system, cache memory, scratchpad memory, register files, etc. The compute slices can be coupled in a ring configuration, where each compute slice can be coupled to a predecessor compute slice and a successor compute slice using a barrier register. A compute slice can only write to a barrier register between it and the successor compute slice, and a successor compute slice can only read from the barrier register. The control unit can control data access, data processing, etc. by the compute slices.

Determining slice offset enables memory dependence prediction in a parallel architecture with compute slices. A processing unit is accessed, comprising a plurality of compute slices, a control unit, and a global aliasing table (GAT). Each compute slice within the plurality of compute slices includes at least one execution unit, is known to a compiler, and is coupled to a successor compute slice and a predecessor compute slice. A first compute slice among the plurality of compute slices executes a load instruction. The load instruction is associated with a target address. The load instruction is predicted that it will alias with a previous store instruction. The previous store instruction executes on a previous compute slice among the plurality of compute slices. The predicting is based on the GAT. The load instruction is stalled until the previous store instruction completes execution on the previous compute slice. The load instruction is allowed to execute.

Programs can be compiled for execution on the processing unit. The compiled programs can comprise a plurality of slice tasks, where the slice tasks can be executed on compute slices within the processing unit. The compute slices can enable a parallel processing architecture. Some slice tasks associated with the program can be executed in parallel, while others must be properly sequenced. The sequential execution and the parallel execution of the slice tasks are dictated in part by the existence of or absence of data dependencies between slice tasks. In a usage example, compute slice A, running slice task A, processes input data and produces output data that is required by compute slice B, running slice task B. Each compute slice can be coupled to a unique local memory disambiguation unit (LMDU). For correct results, slice task A must first generate the input required by slice task B before slice task B can fully execute on compute slice B. Slice task A can be executing on a compute slice a slice distance away from the compute slice executing slice task B. Slice task B can execute speculatively, where the speculative execution does not depend on inputs from slice task A. When slice task B execution does depend on inputs from slice task A, and when slice task B gets to the point where it depends on input from slice A, compute slice B can stall while waiting for results from the predecessor slice. Once the results are obtained, compute slice B can continue to execute slice task B speculatively while slice task A proceeds. Compute slice C, however, holds slice task C which executes instructions that process the same input data as slice task A, and also produces its own output data. Thus, slice task C can be speculatively executed in parallel with slice tasks A and B.

The execution of tasks such as slice tasks can be based on memory access operations. The memory access operations include data loads from memory, data stores to memory, load-modify-store operations, and so on. Some of the slice tasks can share data, provide processed data to other slice tasks, and the like. To continue the usage example above, slice task B executing on compute slice B can include a load instruction that is associated with a target address. The target address can alias to a previous store instruction. An LMDU associated with compute slice B can handle the previous store instruction when the store instruction is within the same slice task as the load instruction. However, in a parallel processing system, the previous store instruction can be associated with a previous slice task that is executed on a previous compute slice. A prediction can be made that the load instruction will alias with a previous store instruction. The prediction can be made based on the contents of the GAT. The prediction can be based on a previous aliasing of the load instruction and previous store instruction. Based on the prediction, the load instruction can be stalled until the previous store instruction completes execution on the previous compute slice. Once the store instruction is complete, the load instruction can be allowed to execute. The predicting, stalling, and allowing can be performed by the control unit.

The block diagram 600 can include a control unit 610 within the processor unit. The control unit can be used to control one or more compute slices, barrier registers, LMDUs, the GAT, and other elements associated with the processing unit. The control unit can operate based on receiving a set of slice tasks from a compiler. The compiler can include a high-level compiler, a hardware language compiler, a compiler developed for use with the processing unit, and so on. The control unit can distribute and allocate slice tasks to compute slices associated with the processing unit. The control unit can be used to commit a result of a slice task to a barrier register as the slice task is executing, or when execution of the slice task has been completed. The control unit can perform checking and control operations. The checking and control operations can include checking that a slice task is a next sequential slice task in a compiled program; distributing slice tasks; cancelling slice tasks; moving pointers such as a head pointer and a tail pointer; allowing a compute slice to commit results to memory; and so on. The control unit can perform state assignment operations. The control unit can assign a state to each compute slice in the plurality of compute slices. The state can include one of idle, executing, holding, or done. The assigned states can be used to determine whether a compute slice is ready to receive a slice task, that data is ready to be committed, etc. The state of a compute slice can be used for exception handling techniques. The exception handling techniques can be associated with nonrecoverable exceptions and recoverable exceptions, interrupts, error codes, illegal operations, etc.

A processing unit can include a plurality of compute slices. The compute slices can be issued, by the control unit, slice tasks for execution. The slice tasks can include blocks of code associated with a compiled program generated by the compiler. In the figure, the compute slices include compute slice 1 620, compute slice 2 630, compute slice 3 640, compute slice 4 650, and compute slice 5 660. The number of compute slices that can be included in the processing unit can be based on a processing architecture, a number of processor cores on an integrated circuit or chip, and the like. A unique local memory disambiguation unit (LMDU) can be included in each compute slice. The LMDU can be used to provide load data obtained from a memory system for processing on the associated code slice. The LMDU can be used to hold store data generated by the compute slice and can be designated for storing in the memory system. The LMDU can detect address aliasing between a load address and a store address of a previously issued store instruction within a slice task. The LMDUs can include LMDU 1 622 coupled to compute slice 1 620; LMDU 2 632 coupled to compute slice 2 630; LMDU 3 642 coupled to compute slice 3 640; LMDU 4 652 coupled to compute slice 4 650; and LMDU 5 662 coupled to compute slice 5 660. The detecting can be based on a memory operation table (MOT) (not shown) within the LMDU. The MOT can forward store information, from the previously issued store instruction, to one or more bytes of information that satisfy data requirements for the load instruction. As the number of compute slices changes for a particular processing unit architecture, the number of LMDUs can change correspondingly.

Recall that a store instruction that must be executed prior to execution of a load instruction can be associated with slice task different from the slice task associated with the load instruction. The two slice tasks can be executed on different compute slices. The two slice tasks can be executing differently. In a usage example, the slice task that includes the store instruction can be executing non-speculatively, while the slice task that includes the load instruction can be executing speculatively. The store instruction can be based on a decision resulting from a conditional instruction such as a branch decision. The load instruction can be predicted to alias with the store instruction based on an entry in the GAT. The entry in the GAT can indicate that the load instruction previously depended on the store instruction and should therefore stall to wait for the store instruction to complete execution. The predicting can be based on prior executions of slice tasks, the ordering of the slice tasks, an offset between the compute slices that execute the slice tasks, etc.

A processing unit can include a plurality of sets of barrier registers. The barrier registers can be used to hold load data to be processed by a compute slice, to receive store data generated by a compute slice, and so on. In a configuration example, a second compute slice can be coupled to a first compute slice by a first barrier register set in the plurality of barrier register sets. In the block diagram, barrier register 1 624 can couple compute slice 2 630 to compute slice 1 620; barrier register 2 634 can couple compute slice 3 640 to compute slice 2 630; barrier register 3 644 can couple compute slice 4 650 to compute slice 3 640; barrier register 4 654 can couple compute slice 5 660 to compute slice 4 650; etc. Slice tasks can be issued to compute slices in an order. In the block diagram 600, the order can be visualized as from left to right. That is, a left-hand compute slice or predecessor compute slice only needs to write to a barrier register coupled to a right-hand compute slice or successor. A successor compute slice does not need to write to a processor compute slice, nor does a predecessor compute slice need to read from a successor compute slice. In an implementation example, a successor compute slice can be to the left or the right of its predecessor. In further embodiments, the plurality of compute slices and the plurality of barrier register sets can be coupled in a ring configuration. Thus, barrier register 6 (not shown) can be coupled between compute slice 5 660 and compute slice 1 620.

Processing of slice tasks by compute slices within the processing unit can be controlled by one or more pointers. Each pointer can point to a compute slice, where the compute slice is executing a slice task. In a usage example, the one or more pointers can include a head pointer 670 and a tail pointer 672. The head pointer can point to a slice task that can be executing non-speculatively. The tail pointer can be pointing to a second slice task, where the second slice task can be executing speculatively. Discussed previously and throughout, in order to reduce the risk of a speculatively executing slice task and its associated data being flushed, a prediction can be made that a load instruction 682 associated with a speculatively executing slice task can alias with a previous store instruction 680. In embodiments, the previous store instruction executes on a previous compute slice among the plurality of compute slices. In other embodiments, the predicting is based on the GAT. The previous compute slice that executes the store instruction can be a distance or offset 690 from the compute slice that executes the load instruction. The GAT can include a saved load instruction and a saved store instruction on which the predicting can be based. The GAT further includes a slice offset. In embodiments, the saving includes a saved slice offset. The slice offset can include an integer count of compute slices. The saved slice offset comprises X+1, where X is a number of compute slices between the first compute slice and the previous compute slice. In the example shown in FIG. 6, the offset is the number of compute slices, 1, between the first compute slice 650 and the previous compute slice, plus 1. Thus, the slice offset equals 2.

Data movement to, from, and within the processing unit, whether loading, storing, transferring, etc., can be accomplished using a variety of techniques. In embodiments, memory system access operations can be performed outside of processing unit, thereby freeing the compute slices within the processing unit to execute slice tasks. Memory access operations, such as autonomous memory operations, can preload data needed by one or more compute slices. The preloaded data can be placed in buffers associated with compute slices that require the data. In additional embodiments, a semi-autonomous memory copy technique can be used for transferring data. The semi-autonomous memory copy technique can be accomplished by the processing unit which generates source and target addresses required for the one or more data moves. The processing unit can further generate a data size such as 8, 16, 32, or 64-bit data sizes, and a striding value. The striding value can be used to avoid overloading a column of storage components such as a cache memory.

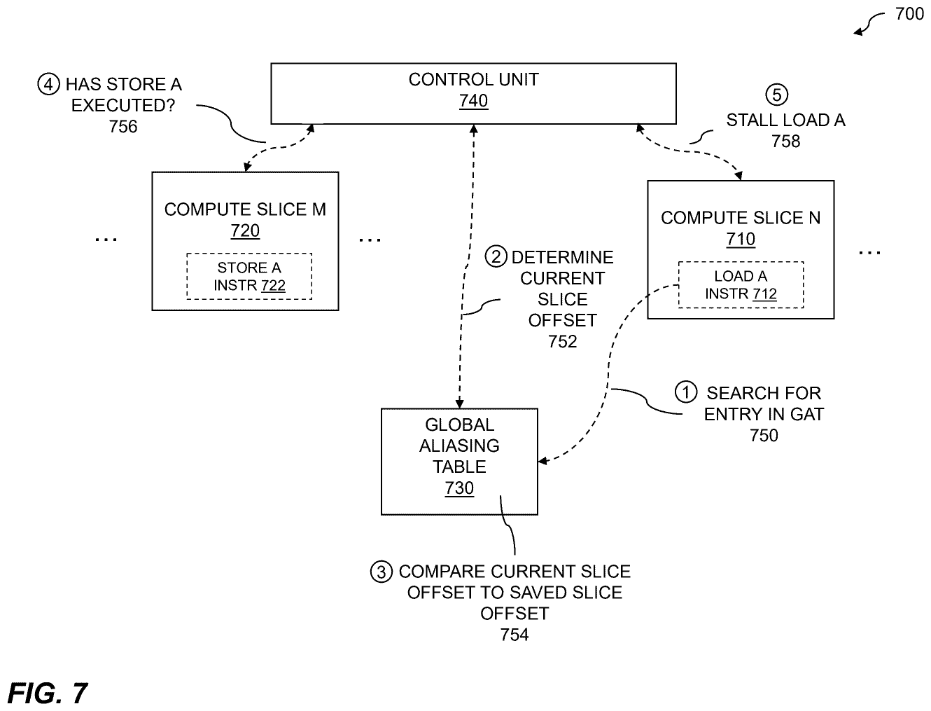

FIG. 7 is a block diagram for memory dependence prediction. Discussed throughout, a load instruction can be predicted to alias with a previous store instruction that executes on a previous compute slice. The predicting can be based on a previous aliasing that was detected during execution of a program. The predicting can be used to determine whether, in the future, the load instruction should be stalled until the previous store instruction completes execution. The stalling, and subsequent allowing execution of the load instruction, enables memory dependence prediction in a parallel architecture with compute slices. A processing unit is accessed. The processing unit comprises a plurality of compute slices, a control unit, and a global aliasing table (GAT). Each compute slice within the plurality of compute slices includes at least one execution unit, is known to a compiler, and is coupled to a successor compute slice and a predecessor compute slice. A first compute slice among the plurality of compute slices executes a load instruction. The load instruction is associated with a target address. The load instruction is predicted that it will alias with a previous store instruction. The previous store instruction executes on a previous compute slice among the plurality of compute slices. The predicting is based on the GAT. The predicting can include a slice offset. The load instruction is stalled until the previous store instruction completes execution on the previous compute slice. The load instruction is allowed to execute.

A processing unit can include a plurality of compute slices. In the block diagram 700, the compute slices within the processing unit can include a first compute slice N 710 and a previous compute slice M 720. Additional adjacent compute slices between compute slice M and compute slice N can be included, with their associated barrier registers. Compute slice N can execute a load instruction. In the block diagram 700, the executed load instruction can include load instruction A 712. The load instruction can be associated with a target address.

The target address can include a memory address. The previous compute slice M can execute a store instruction. In the block diagram 700, the executed store instruction can include store instruction A 722. The store instruction can be associated with a target address. The address associated with the load instruction can be searched against entries in a global aliasing table 730. Embodiments can include searching 750 (circle 1), in the GAT, for an entry which includes the load instruction. The GAT entry can include the address of the load, and one or more addresses of the store. The one or more addresses of the store can include instantiations of the store instruction in one or more slice tasks.

Each instantiation of the store instruction can be associated with a slice offset. Embodiments can include determining 752 (circle 2) a current slice offset. The current slice offset can include a number associated with a quantity of compute slices. In the block diagram 700, the current slice offset can be determined by a control unit 740. In embodiments, the current slice offset can comprise X+1, where X is a number of compute slices between the first compute slice and the previous compute slice. The current slice offset can be used to predict that the load instruction will alias with a previous store instruction. Embodiments include comparing 754 (circle 3) the current slice offset to the saved slice offset. If a match is found, then the prediction can be made that the load instruction will alias with the previous store instruction. The prediction can indicate that the load instruction must wait for the store instruction to complete. Embodiments include determining 756 (circle 4) whether the store instruction has completed execution. The completion of execution can be based on a number of cycles, a flag, a signal, and so on. Embodiments include stalling 758 (circle 5) the load instruction. The load instruction can be stalled pending completion of executing the store instruction. The load instruction can be allowed to execute by restarting the first compute slice. More than one compute slice can be restarted. Embodiments can include restarting one or more compute slices among the plurality of compute slices. The restarting can include the first compute slice, a tail slice, and every compute slice between the first compute slice and the tail slice.

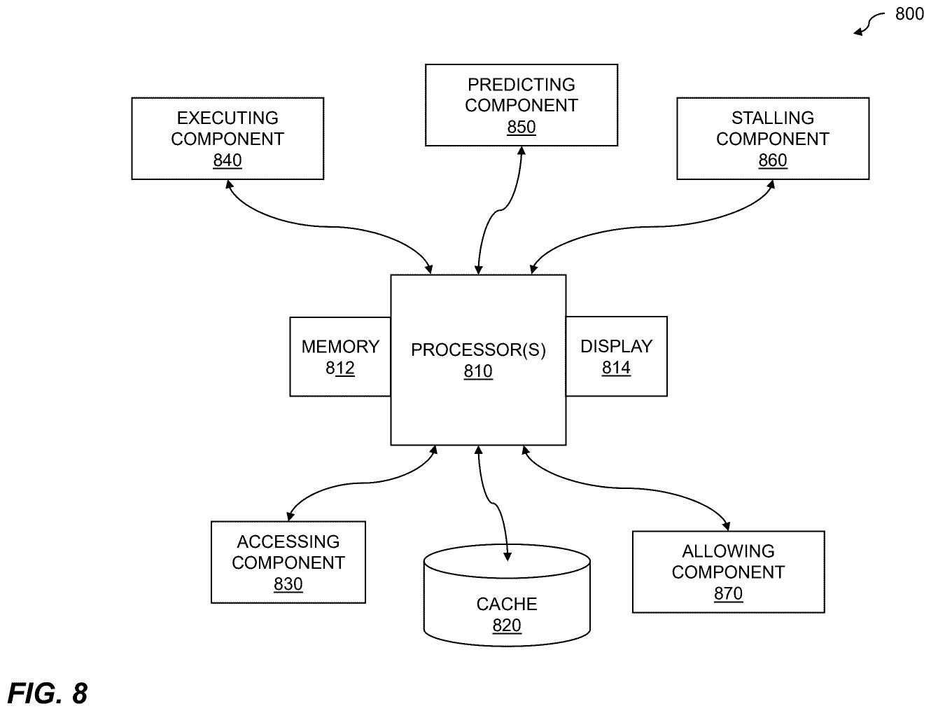

FIG. 8 is a system diagram for memory dependence prediction in a parallel architecture with compute slices. The system 800 can include one or more processors 810, which are coupled to a memory 812 which stores instructions. The system 800 can further include a display 814 coupled to the one or more processors 810 for displaying data; a global aliasing table (GAT); intermediate steps; slice tasks; topologies including systolic, vector, cyclic, spatial, streaming, or VLIW topologies; and so on. In embodiments, one or more processors 810 are coupled to the memory 812, wherein the one or more processors, when executing the instructions which are stored, are configured to: access a processing unit comprising a plurality of compute slices, a control unit, and a global aliasing table (GAT), wherein each compute slice within the plurality of compute slices includes at least one execution unit, is known to a compiler, and is coupled to a successor compute slice and a predecessor compute slice; execute, by a first compute slice among the plurality of compute slices, a load instruction, wherein the load instruction is associated with a target address; predict that the load instruction will alias with a previous store instruction, wherein the previous store instruction executes on a previous compute slice among the plurality of compute slices, and wherein the predicting is based on the GAT; stall the load instruction until the previous store instruction completes execution on the previous compute slice; and allow the load instruction to execute. The compute slices can include compute slices within one or more integrated circuits or “chips,” compute slices or cores configured within one or more programmable chips such as application specific integrated circuits (ASICs), field programmable gate arrays (FPGAs), heterogeneous processors configured as a mesh, standalone processors, etc.

The system 800 can include a cache 820. The cache 820 can be used to store data such as scratchpad data, slice tasks for compute slices, load instruction alias predictions, global aliasing tables, intermediate results, microcode, branch decisions, and so on. The cache can comprise a small, local, easily accessible memory available to one or more compute slices. In embodiments, the data that is stored can include operations, data, and so on. The system 800 can include an accessing component 830. The accessing component 830 can include control logic and functions for accessing a processing unit. The processing unit can be accessible within an integrated circuit, an application-specific integrated circuit (ASIC), a programmable unit such as a field-programmable gate array (FPGA), and so on. The processing unit can comprise a plurality of compute slices, a control unit, and a global aliasing table (GAT). The processing unit can further comprise a memory system. Each compute slice within the plurality of compute slices includes at least one execution unit. A compute slice can include one or more processors, processor cores, processor macros, processor cells, and so on. Each compute slice can include an amount of local storage. The local storage may be accessible by one or more compute slices. The compute slices can be organized in a ring. Compute slices within the ring can be accessed using pointers. The pointers can include a processing unit comprising a plurality of compute slices, a control unit, and a global aliasing table (GAT), wherein each compute slice within the plurality of compute slices includes at least one execution unit, is known to a compiler, and is coupled to a successor compute slice and a predecessor compute slice, a tail pointer, and the like.

Each compute slice is coupled to a successor compute slice and a predecessor compute slice. The coupling of the compute slice to the successor compute slice and to the predecessor compute slice can be accomplished by a barrier register set in the plurality of barrier register sets. The barrier register set provides for communication of data between successive compute slices. Communication between and among compute slices can be accomplished using a bus such as an industry standard bus, a ring bus, a network such as a wired or wireless computer network, etc. The ring bus can be implemented as a distributed multiplexor (MUX). Each compute slice within the plurality of compute slices can be coupled to a local memory disambiguation unit (LMDU) within a plurality of LMDUs. Discussed below, the LMDUs can hold one or more store instructions, one or more load instructions, and so on. Each LMDU in the plurality of LMDUs is coupled to a global aliasing table (GAT). The GAT can include load and store information. The contents of the GAT can be used to predict that a load instruction will alias with a previous store instruction (discussed below).

The system 800 includes an executing component 840. The executing component 840 can include control and functions for executing, by a first compute slice among the plurality of compute slices, a load instruction. The load instruction is associated with a target address. The load instruction can initiate a memory access operation. The targeted address can include a memory address, where the memory can include a local memory, a cache memory, a shared memory, a system memory, etc. The executing can include a second load instruction, where the second load instruction can include the load address. The executing by the first compute slice can be controlled by the controller. The first compute slice can be coupled to a local memory disambiguation unit (LMDU) within the plurality of LMDUs. The LMDU can be used to track load and store operations associated with one or more slice tasks executing on the compute slice. The slice task can include a task that is running speculatively or running non-speculatively. The assignment of a slice task to a compute slice can be accomplished by the controller using pointers. The pointers can include a head pointer, a tail pointer, and so on. The head pointer can point to a slice task that can be running non-speculatively. The first slice task can include a load instruction, a store instruction, etc. The accessing of storage can be accomplished using a bus, a network such as a network-on-chip (NOC), and so on. The head slice can be a state within the control unit and can point to the first compute slice running a slice task non-speculatively.

The system 800 includes a predicting component 850. The predicting component 850 can include control and functions for predicting that the load instruction will alias with a previous store instruction. The previous store instruction executes on a previous compute slice among the plurality of compute slices, wherein the predicting is based on the GAT. A slice task executing on a compute slice can execute a plurality of memory operations, such as load operations and store operations, to a given address. Such loads and stores can be handled by a local memory disambiguation unit (LMDU) coupled to the compute slice. Note that other slice tasks executing on other compute slices can also access the same memory address. Note further that the one slice task can be executing non-speculatively, while other slice tasks can be executing speculatively. A prediction about how access to the memory address can be based on execution of two or some slice tasks on two or more compute slices. The prediction can include that substantially similar slice tasks will execute operations that perform substantially similar memory accesses. Thus, the prediction can be made based on the contents of the GAT.

In embodiments, the predicting can include searching, in the GAT, for an entry which includes the load instruction, wherein the entry which includes the load instruction is not found. When the load instruction is not found, then the prediction cannot be made whether a previous, “upstream,” or non-speculatively executing slice task will access the memory address. As a result, the compute slice executing the load instruction, the compute slice pointed to by a tail pointer, and all compute slices in between can be cancelled. In other embodiments, the load instruction aliased with the previous store instruction. Since there is an alias of the load instruction with the previous store instruction, a prediction can be made regarding a sequence of task slices that can precede the load instruction. Further embodiments can include saving, in an entry of the GAT, an instruction address of the load instruction. The instruction address of the load instruction that is saved is associated, in the entry of the GAT, with an instruction address of the previous store instruction. The saving the load instruction based on aliasing can enable the predicting discussed previously. In embodiments, the saving includes a saved slice offset, wherein the saved slice offset comprises X+1, wherein X is a number of compute slices between the first compute slice and the previous compute slice. In a usage example, the next previous compute slice to the first compute slice has an offset of 1, the second previous compute slice to the first compute slice has an offset of 2, and so on.

In further embodiments, the predicting can include finding, in the GAT, an entry which includes the previous store instruction that was associated with the load instruction. The load instruction can alias with a previous store instruction and can be dependent on the previous store instruction executing prior to execution of the load instruction. Further embodiments can include determining a current slice offset, wherein the current slice offset comprises Y+1, wherein Y is a number of compute slices between the first compute slice and the previous compute slice. The current slice offset can include 1 for an adjacent compute slice, 2 for a compute slice adjacent to the adjacent compute slice, and so on. The current slice offset can be compared to previously stored elements in the GAT. Further embodiments can include comparing the current slice offset to a saved slice offset. The comparison can be based on a line-by-line comparison of GAT entries, can be based on a content accessible comparison, and the like. In embodiments, the current slice offset and the saved slice offset are equal. Further embodiments can include deciding, by the control unit, that the previous compute slice is executing a slice task that includes the previous store instruction. The decision by the control unit can generate a prediction that the data stored by the store instruction can be the data required for the load instruction.

The system 800 includes a stalling component 860. The stalling component 860 can include control and functions for stalling the load instruction until the previous store instruction completes execution on the previous compute slice. The previous store instruction changes the contents of the memory address associated with the store instruction. The load instruction can be stalled while waiting for the store instruction to complete. The stalling can prevent a memory access race condition by which erroneous, corrupted, or stale data could be improperly loaded. The stalling can be based on a number of cycles, an amount of time, a flag, a control signal, and so on. Further embodiments can include stalling, by the first compute slice, the load instruction, until the previous compute slice completes execution of the previous store instruction. With execution of the previous store instruction completed, valid data can be loaded from the memory address accessed by the previous store instruction and the load instruction.

The system 800 includes an allowing component 870. The allowing component 870 can include control and functions for allowing the load instruction to execute. The allowing the load instruction can include restarting the load instruction. The predicting, the stalling, and the allowing can include more than one store instruction. In embodiments, the predicting, the stalling, and the allowing can include a second previous store instruction. The second previous store instruction can be associated with a slice task executing on a previous compute slice. In embodiments, the second previous store instruction executes on the previous compute slice among the plurality of compute slices, wherein the slice offset is associated, in the GAT, with the second previous store instruction. The second previous store instruction can be executed on a compute slice that is “farther afield” than the previous compute slice. In embodiments, the second previous store instruction can execute on a second previous compute slice among the plurality of compute slices, and wherein the second previous store instruction is associated, in the GAT, with a second slice offset. The second slice offset can be based on the number of compute slices between the first compute slice and a previous compute slice. In embodiments, the second slice offset comprises Z+1, wherein Z is a number of compute slices between the first compute slice and the second previous compute slice.

The system 800 can include a computer program product embodied in a non-transitory computer readable medium for checking memory operations, the computer program product comprising code which causes one or more processors to generate semiconductor logic for: accessing a processing unit comprising a plurality of compute slices, a control unit, and a global aliasing table (GAT), wherein each compute slice within the plurality of compute slices includes at least one execution unit, is known to a compiler, and is coupled to a successor compute slice and a predecessor compute slice; executing, by a first compute slice among the plurality of compute slices, a load instruction, wherein the load instruction is associated with a target address; predicting that the load instruction will alias with a previous store instruction, wherein the previous store instruction executes on a previous compute slice among the plurality of compute slices, and wherein the predicting is based on the GAT; stalling the load instruction until the previous store instruction completes execution on the previous compute slice; and allowing the load instruction to execute.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for checking memory operations comprising:
accessing a processing unit comprising a plurality of compute slices, a control unit, and a global aliasing table (GAT), wherein each compute slice within the plurality of compute slices includes at least one execution unit, is known to a compiler, and is coupled to a successor compute slice and a predecessor compute slice;
executing, by a first compute slice among the plurality of compute slices, a load instruction, wherein the load instruction is associated with a target address;
predicting that the load instruction will alias with a previous store instruction, wherein the previous store instruction executes on a previous compute slice among the plurality of compute slices, and wherein the predicting is based on the GAT;
stalling the load instruction until the previous store instruction completes execution on the previous compute slice; and
allowing the load instruction to execute.

2. The method of claim 1 wherein the predicting includes searching, in the GAT, for an entry which includes the load instruction, wherein the entry which includes the load instruction is not found.

3. The method of claim 2 wherein the load instruction aliased with the previous store instruction.

4. The method of claim 3 further comprising saving, in an entry of the GAT, an instruction address of the load instruction, wherein the instruction address of the load instruction is associated, in the entry of the GAT, with an instruction address of the previous store instruction.

5. The method of claim 4 wherein the saving includes a saved slice offset, wherein the saved slice offset comprises X+1, wherein X is a number of compute slices between the first compute slice and the previous compute slice.

6. The method of claim 5 further comprising restarting one or more compute slices among the plurality of compute slices, wherein the restarting includes the first compute slice, a tail slice, and every compute slice between the first compute slice and the tail slice.

7. The method of claim 4 wherein the saving includes a second previous store instruction.

8. The method of claim 4 wherein the saving includes evicting, from the GAT, an oldest entry, wherein the GAT is full.

9. The method of claim 1 wherein the predicting includes finding, in the GAT, an entry which includes the previous store instruction that was associated with the load instruction.

10. The method of claim 9 further comprising determining a current slice offset, wherein the current slice offset comprises Y+1, wherein Y is a number of compute slices between the first compute slice and the previous compute slice.

11. The method of claim 10 further comprising comparing the current slice offset to a saved slice offset, wherein the current slice offset and the saved slice offset are equal.

12. The method of claim 11 further comprising deciding, by the control unit, that the previous compute slice is executing a slice task that includes the previous store instruction.

13. The method of claim 12 further comprising verifying that the previous compute slice has not yet executed the previous store instruction.

14. The method of claim 13 further comprising stalling, by the first compute slice, the load instruction, until the previous compute slice completes execution of the previous store instruction.

15. The method of claim 14 further comprising evicting an entry of the GAT, wherein the load instruction and the previous store instruction did not alias.

16. The method of claim 1 wherein the predicting, the stalling, and the allowing includes a second previous store instruction.

17. The method of claim 16 wherein the second previous store instruction executes on the previous compute slice among the plurality of compute slices, wherein the slice offset is associated, in the GAT, with the second previous store instruction.

18. The method of claim 16 wherein the second previous store instruction executes on a second previous compute slice among the plurality of compute slices, and wherein the second previous store instruction is associated, in the GAT, with a second slice offset.

19. The method of claim 18 wherein the second slice offset comprises Z+1, wherein Z is a number of compute slices between the first compute slice and the second previous compute slice.

20. The method of claim 1 further comprising evicting an entry of the GAT, wherein the load instruction and the previous store instruction did not alias.

21. A computer program product embodied in a non-transitory computer readable medium for checking memory operations, the computer program product comprising code which causes one or more processors to generate semiconductor logic for:
accessing a processing unit comprising a plurality of compute slices, a control unit, and a global aliasing table (GAT), wherein each compute slice within the plurality of compute slices includes at least one execution unit, is known to a compiler, and is coupled to a successor compute slice and a predecessor compute slice;
executing, by a first compute slice among the plurality of compute slices, a load instruction, wherein the load instruction is associated with a target address;
predicting that the load instruction will alias with a previous store instruction, wherein the previous store instruction executes on a previous compute slice among the plurality of compute slices, and wherein the predicting is based on the GAT;
stalling the load instruction until the previous store instruction completes execution on the previous compute slice; and
allowing the load instruction to execute.

22. A computer system for checking memory operations comprising:
a memory which stores instructions;
one or more processors coupled to the memory, wherein the one or more processors, when executing the instructions which are stored, are configured to:
access a processing unit comprising a plurality of compute slices, a control unit, and a global aliasing table (GAT), wherein each compute slice within the plurality of compute slices includes at least one execution unit, is known to a compiler, and is coupled to a successor compute slice and a predecessor compute slice;
execute, by a first compute slice among the plurality of compute slices, a load instruction, wherein the load instruction is associated with a target address;
predict that the load instruction will alias with a previous store instruction, wherein the previous store instruction executes on a previous compute slice among the plurality of compute slices, and wherein the predicting is based on the GAT;
stall the load instruction until the previous store instruction completes execution on the previous compute slice; and
allow the load instruction to execute.
